(19) United States
(12) Patent Application Publication
(10) Pub. No.: US 2016/0261965 A1
(43) Pub. Date: Sep. 8, 2016

(54) METHOD FOR ARRANGING MICROPHONES

(71) Applicant: HARMAN INTERNATIONAL INDUSTRIES INCORPORATED, Stamford, CT (US)

(72) Inventors: Weixing GAO, Weifang (CN); Alan MICHEL, Carmel, IN (US); Zongying XIA, Licang District Qingdao (CN)

(21) Appl. No.: 15/028,842

(22) PCT Filed: Oct. 16, 2013
(86) PCT No.: PCT/CN2013/085313

§ 371 Date: Apr. 12, 2016

(51) Int. Cl. H04R 29/00; H04R 31/00; H04R 19/04; H04R 1/08

(52) U.S. Cl. CPC H04R 29/006; H04R 1/08; H04R 31/00; H04R 19/04; H04R 2201/403; H04R 2201/401

(57) ABSTRACT

A method for packaging a plurality of microphones is provided. The method includes: obtaining a first parameter value, a second parameter value, and position information for each of the plurality of microphones and sorting the plurality of microphones by both the first parameter and the second parameter to obtain a sorted list which contains position information of the plurality of microphones. The method further includes packaging the plurality of microphones according to the sorted list.

### TECHNICAL FIELD

The present application generally relates to method for arranging microphones.

### BACKGROUND

Microphones, such as micro electrical mechanical system (MEMS) microphones, used in a microphone array are usually required to be matched. In other words, for one parameter, these microphones are required to have parameter values close enough to each other.

In one conventional method, one parameter of each of a large quantity of microphones is measured, and the microphones are put into different bins based on their measured parameter values such that microphones having parameter values within different parameter value ranges are put in corresponding bins. Then the microphones are packaged according to a descending or ascending order of parameter value ranges of the bins, and such packaged microphones can be used to make microphone arrays which require the parameter matched.

In another conventional method, before packaging, microphones are tuned such that for one parameter, these microphones have parameter values very close to a target value. However, this requires the microphones to have embedded non-volatile memory to store gain correction, which increases the cost significantly. In addition, no tuning equipment, which is able to tune two or more parameters, is available.

### SUMMARY

In one embodiment, a method for arranging a plurality of microphones is provided. The method may include: measuring the plurality of microphones to obtain their first parameter values and second parameter values; and arranging the plurality of microphones such that their first parameter values are substantially in a descending or ascending order and their second parameter values are substantially in a descending or ascending order.

In some embodiments, the first parameter may be sensitivity at a first frequency, and the second parameter may be relative sensitivity between the first frequency and a second frequency.

In some embodiments, the first parameter may be sensitivity at 1K Hz, and the second parameter may be 80 Hz/1 K Hz relative sensitivity.

In one embodiment, a method for arranging a plurality of microphones is provided. The method may include: measuring the plurality of microphones to obtain their first parameter values and second parameter values; and arranging the plurality of microphones substantially in order of both the first parameter and the second parameter.

In one embodiment, a method for arranging a plurality of microphones is provided. The method may include: measuring at least two parameters of each of the plurality of microphones; and arranging the plurality of microphones in substantially order of the at least two parameters.

In one embodiment, a method for packaging a plurality of microphones is provided. The method may include: obtaining a first parameter value, a second parameter value and position information of each of the plurality of microphones; sorting the plurality of microphones by both the first parameter and the second parameter to obtain a sorted list which contains position information of the plurality of microphones; and packaging the plurality of microphones according to the sorted list.

In some embodiments, the first parameter may be sensitivity at a first frequency, and the second parameter may be relative sensitivity between the first frequency and a second frequency.

In some embodiments, the first parameter may be sensitivity at 1 K Hz, and the second parameter may be 80 Hz/1 K Hz relative sensitivity.

In some embodiments, the plurality of microphones may be sorted using a raster scanning algorithm or a traveling salesman algorithm.

In one embodiment, a package of a plurality of microphones is provided, where the plurality of microphones are arranged substantially in order of both a first parameter and a second parameter.

In some embodiments, the package of the plurality of microphones may be a tape and reel.

In some embodiments, the first parameter may be sensitivity at a first frequency, and the second parameter may be relative sensitivity between the first frequency and a second frequency.

In some embodiments, the first parameter may be sensitivity at 1K Hz, and the second parameter may be 80 Hz/1 K Hz relative sensitivity.

In one embodiment, a method for making microphone arrays, each of which includes at least two microphones, is provided. The method may include: obtaining a first parameter value and a second parameter value of each of a plurality of microphones; sorting the plurality of microphones by both the first parameter and the second parameter; and making microphone arrays using the sorted microphones.

In one embodiment, a method for packaging a plurality of microphones is provided. The method may include: measuring the plurality of microphones to obtain their first parameter values; sorting the plurality of microphones by the first parameter; and packaging the plurality of microphones according to the sorted order.

In some embodiments, the first parameter may be sensitivity at a first frequency.

In some embodiments, the plurality of microphones are packaged to obtain a tape of microphones.

In one embodiment, a package of a plurality of microphones is provided, where the plurality of microphones in the package are arranged in order of a first parameter.

In some embodiments, the package of the plurality of microphones may be a tape of microphones.

In some embodiments, the first parameter may be sensitivity at a first frequency.

In one embodiment, a method for making microphone arrays, each of which includes at least two microphones, is provided. The method may include: obtaining a first parameter value of each of a plurality of microphones; sorting the plurality of microphones by the first parameter; and making microphone arrays using the plurality of microphones according to the sorted order.

In some embodiments, the first parameter may be sensitivity at a first frequency.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 illustrates a schematic flow chart of a method for packaging microphones according to one embodiment.

FIG. 2 schematically shows a system for packaging microphones according to one embodiment.

FIG. 3 illustrates an example plot showing how microphones are sorted according to one embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

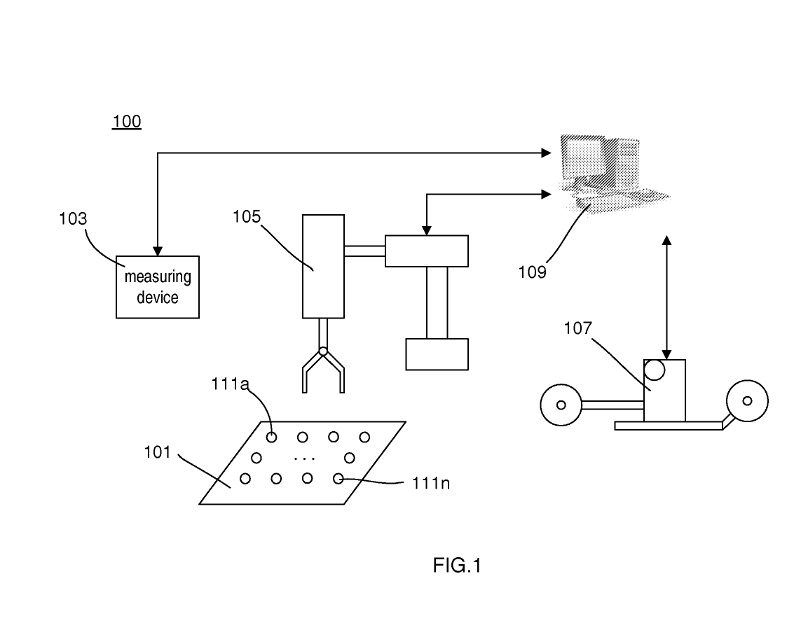

FIG. 1 schematically shows a system 100 for packaging microphones according to one embodiment. The system 100 includes a holding tray 101, a measuring device 103, a manipulator arm 105, a tape and reel machine 107, and a computer 109 which is connected with the measuring device 103, the manipulator arm 105 and the tape and reel machine 107.

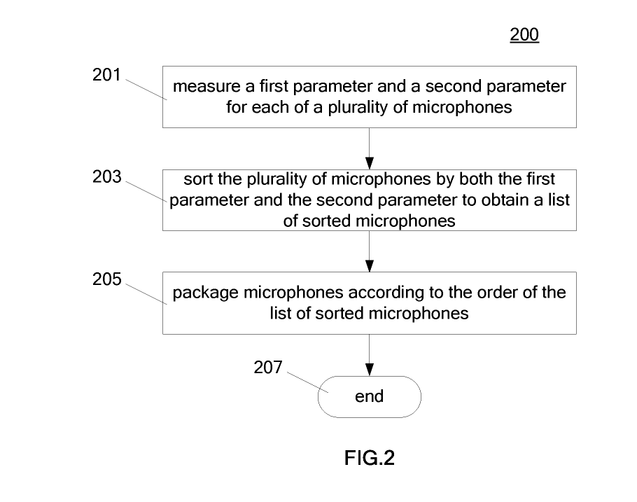

FIG. 2 illustrates a schematic flow chart of a method 200 for packaging microphones according to one embodiment.

In 201, measure a first parameter and a second parameter for each of a plurality of microphones. Referring to FIG. 1, microphones 111a-111n may be loaded on the holding tray 101. In some embodiments, the computer 109 may control the manipulator arm 105 to fetch the microphones from the holding tray 101, deliver them to the measuring device 103 for measurement of the first parameter and the second parameter, and put them back to the holding tray 101 after the measurement. When a microphone is measured and put back to the holding tray 101, the computer 109 may record its measurement data and position information. After microphones 111a-111n are measured, a list of microphones, their corresponding measurement data and their position information may be obtained.

In 203, sort the plurality of microphones by both the first parameter and the second parameter to obtain a list of sorted microphones. In some embodiments, the computer 109 may sort the microphones. Any suitable methods and/or algorithms may be used to sort the microphones, for example, a raster scanning algorithm or a traveling salesman algorithm may be used to sort the microphones.

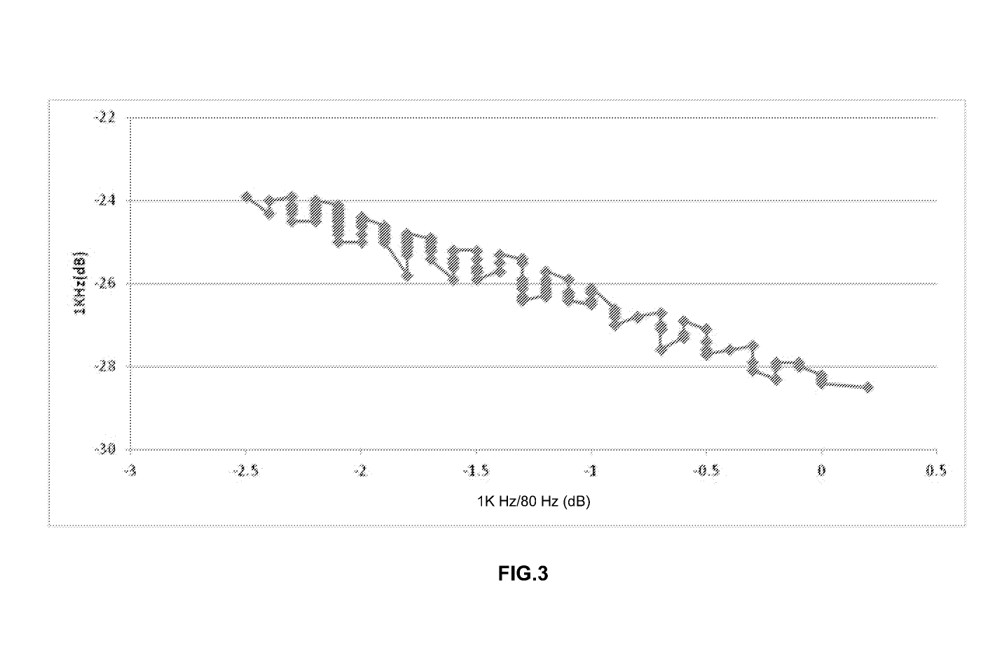

When the microphones are sorted by two parameters, they may be mapped into a two dimensional space. To ensure that neighboring microphones have very close parameter values, those points which are relatively far away from other points may be filtered out, and the microphones corresponding to these filtered out points may be packaged in next round with other microphones. FIG. 3 illustrates an example plot showing how microphones are sorted by 1 K Hz sensitivity and 1 K Hz/80 Hz relative sensitivity.

After the microphones 111a-111n are sorted, the computer 109 may generate a list of sorted microphones which list contains position information of the microphones, and their parameter values. Below Table 1 is an example of the list.

TABLE 1

| | | | 1K Hz/80 Hz |
|---|---|---|---|
| Number | Position | 1K Hz Sensitivity | Relative Sensitivity |
| 1 | Row 4, Column 3 | −24 dB | −2.5 dB |
| 2 | Row 2, Column 1 | −24.5 dB | −2.4 dB |
| . . . | . . . | . . . | . . . |
| n | Row 5, Column 6 | −28.5 dB | 0.3 dB |

In 205, package microphones according to the order of the list of sorted microphones such that the packaged microphones are arranged substantially in order of both the first parameter and the second parameter. In one example, the computer 109 may control the manipulator arm 105 to fetch microphones from the holding tray 101 and feed them to the tape and reel machine 107 according to the order of the list of sorted microphones, such that in the packaged tape and reel of microphones, the packaged microphones are arranged substantially in order of both the first parameter and the second parameter. Therefore, when the tape and reel of microphones is used to make microphone arrays which require microphones in one array have very close first parameter values and second parameter values, one only needs to get microphones from the tape and reel one by one.

In 207, the method 200 end.

There is little distinction left between hardware and software implementations of aspects of systems; the use of hardware or software is generally a design choice representing cost vs. efficiency tradeoffs. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for arranging a plurality of microphones comprising:
measuring the plurality of microphones to obtain a first parameter value and a second parameter value for each microphone; and
arranging the plurality of microphones substantially in order based on both the first parameter value and the second parameter value.

2. The method of claim 1, wherein the first parameter value includes a sensitivity at a first frequency, and the second parameter value includes a relative sensitivity between the first frequency and a second frequency.

3. The method of claim 2, wherein the first frequency is 1 K Hz, and the relative sensitivity is 80 Hz/1 K Hz relative sensitivity.

4. The method of claim 1, wherein the plurality of microphones are arranged using a traveling salesman method.

5. (canceled)

6. A method for packaging a plurality of microphones comprising:
obtaining a first parameter value, a second parameter value and position information of each of the plurality of microphones;
sorting the plurality of microphones by both the first parameter value and the second parameter value to obtain a sorted list which contains position information of the plurality of microphones; and
packaging the plurality of microphones according to the sorted list.

7. The method of claim 6, wherein the first parameter value includes a sensitivity at a first frequency, and the second parameter value includes a relative sensitivity between the first frequency and a second frequency.

8. The method of claim 7, wherein the first frequency is 1 K Hz, and the relative sensitivity is 80 Hz/1 K Hz.

9. The method of claim 6, wherein the plurality of microphones is sorted using a traveling salesman method.

10. (canceled)

11. (canceled)

12. (canceled)

13. (canceled)

14. (canceled)

15. A method for packaging a plurality of microphones, comprising:
measuring the plurality of microphones to obtain a first parameter value for each of the microphones;
sorting the plurality of microphones based on the first parameter value for each of the microphones into a sorted order; and
packaging the plurality of microphones according to the sorted order.

16. The method of claim 15, wherein the first parameter value includes a sensitivity at a first frequency.

17. The method of claim 15, wherein the plurality of microphones is packaged to obtain a tape of microphones.

18. (canceled)

19. (canceled)

20. (canceled)

21. A method for making microphone arrays, each of the microphone arrays including at least two microphones, the method comprising:
obtaining a first parameter value of each of a plurality of microphones;
sorting the plurality of microphones by the first parameter value into a sorted order; and
making microphone arrays using the plurality of microphones according to the sorted order.

22. The method of claim 21, wherein the first parameter value is a sensitivity at a first frequency.
